(19) United States
(12) Patent Application Publication
(10) Pub. No.: US 2011/0097256 A1
(43) Pub. Date: Apr. 28, 2011

(54) METHOD FOR PREPARING HIGH-PURITY METALLURGICAL-GRADE SILICON

(75) Inventor: Sergio Pizzini, Sesto Calende (IT)

(73) Assignee: N.E.D. SILICON S.P.A., OSIMO (IT)

(21) Appl. No.: 12/999,570

(22) PCT Filed: May 27, 2009
(86) PCT No.: PCT/EP2009/056477

§ 371 Date: Dec. 16, 2010

(30) Foreign Application Priority Data
Jun. 16, 2008 (IT) MI2008A001085

(51) Int. Cl. C01B 33/021

(52) U.S. Cl. 423/349

(57) ABSTRACT

A method for preparing silicon for photovoltaic use starting from metallurgical-grade silicon, comprising the following steps, performed by means of devices made of materials suitable to prevent silicon contamination: providing a silica powder and a carbon black having a reduced content of boron, phosphorus and metallic impurities and a binding agent; preparing a mixture of silica powder, carbon black and binding agent and preparing pellets with the mixture; subjecting the pellets to a first thermal treatment; subjecting the heat-treated pellets to carbon reduction, so as to obtain silicon in the molten state; subjecting the silicon in the molten state to a first purification; subjecting to directional solidification the silicon in the molten state in a directional solidification furnace, so as to obtain silicon for photovoltaic use.

### TECHNICAL FIELD

The present invention relates to a method for preparing high-purity metallurgical-grade silicon, aiming in particular to the production of photovoltaic cells.

### BACKGROUND ART

It is known that most of the silicon for photovoltaic use originates from the waste silicon of the electronic industry or directly from polycrystalline silicon grown by means of the Siemens process or variations thereof. This electronic-grade silicon is perfectly suitable for applications of the photovoltaic type in terms of quality but requires a preparation that is expensive both in terms is of cost and in terms of energy, as is known, among others, from PCT WO/2007/106860 by Amendola et al. Moreover, this preparation requires the use of precursors that are harmful to the environment, such as trichlorosilane. Recently, granular silicon and powdered silicon have become a low-cost alternative due to the use of silane as a precursor and thanks to a simpler processing technology based on silane decomposition.

However, both of these materials derive from metallurgical-grade silicon, which is converted with different processes to a gaseous precursor which can then be purified by means of conventional procedures.

Metallurgical-grade silicon can be an important source of silicon with potentially reduced energy consumption and costs, provided that its quality can be brought to the degree of quality of materials for photovoltaic use, according to which boron and phosphorus must be reduced to a level that is possibly equal to, or lower than, 0.1 ppm by weight and, on the basis of the most recent literature (L. J. Gerlings et al., Proc. 20th European Photovoltaic Solar Energy Conf., 6-10 Jun. 2005, page 619-622), a total content of metallic impurities of approximately 20 ppm by weight, titanium at 0.17 ppm by weight and aluminum at 0.08 ppm by weight, whereas metallurgical-grade silicon contains approximately 10-50 ppm by weight for the boron and phosphorus and a few thousand ppm by weight for the metals.

Several methods have been used in the past to purify metallurgical-grade silicon by using liquid/liquid extraction procedures, for example the procedures described in U.S. Pat. No. 4,241,037 in the name of Pizzini et al., US 2005/0139148 A1 in the name of Fujiwara et al., and US 2007/0245854 in the name of Lynch et al., or “gas sparging” procedures for removing boron and phosphorus, followed by processes for chemical leaching on crumbled materials already subjected to liquid/liquid extraction or gas sparging, using for example the Silgrain process (U.S. Pat. No. 4,539,194) or the process disclosed in U.S. Pat. No. 6,861,040 filed by Elkem ASA and devised by Ceccaroli et al.

Generally, the last purification passage consists in performing one or two steps of directional solidification in an appropriately provided furnace in order to remove metallic impurities.

The number of directional solidification steps depends on the effectiveness of the leaching procedure and on the initial content of metallic impurities: generally, two directional solidification steps are required in order to achieve the degree of quality desired for photovoltaic use.

Up to now, none of these processes have been able to reduce costs significantly and at the same time obtain the quality required for the manufacture of efficient solar cells, as mentioned in US 2007/0128099 A1, filed by Elkem ASA and devised by Enebakk et al. As recently reported by Gerlings, a mediocre-quality silicon in fact does not meet the fundamental requirement of a silicon suitable as raw material for preparing solar cells, even if it is mixed with electronic-grade silicon.

The main problem of these processes is in fact the limited efficiency of the removal of boron and phosphorus.

This problem appears to have been avoided by using a new concept of silicon purification as proposed by Amendola et al. in PCT WO/2007/106860. However, the described method does not seem to lend itself easily to development on an industrial scale.

According to a further approach, described in PCT WO/2008/031229 in the name of Silicium Becancour Inc., a form of silicon with higher purity can be prepared according to a process that uses a device provided with an oxycombustion burner to melt the low-purity silicon and to obtain a higher-purity molten silicon. This device can include a rotary-drum furnace and the melting of low-purity silicon can be performed at a temperature from 1410° C. to 1700° C. in a reducing or oxidizing atmosphere. However, particularly long treatment times are necessary in order to obtain a substantial removal of the boron from the low-purity material.

Another concept, based on the thermal treatment in vacuum of finely ground metallurgical-grade silicon particles has been described in PCT WO 2005/061383. However, with this method only the phosphorus was removed efficiently and only at a level that was far from the required value.

Therefore, as also noted in patent applications US 2005/0074388 and US 2005/0053539, currently it is possible to obtain only a medium-quality silicon (total content of impurities from 100 to 400 ppm by weight, boron from 0.5 to 3 ppm by weight) by means of the direct purification of metallurgical-grade silicon, at the cost of a long series of intermediate purification steps and with substantial losses of material, starting from a minimum of 30%.

Although the preparation of silicon for photovoltaic use having a low content of boron, phosphorus and metallic impurities has been suggested for example by the Advanced Carbothermal Reduction (ACR) process by Siemens, this procedure has never been developed further, despite the promising results (Aulich, H. A.; Schulze, F. W.; Urbach, H. P.; Lerchenberger, A. in JPL Proceedings of the Flat-Plate Solar Array Project Workshop on Low-Cost Polysilicon for Terrestrial Photovoltaic Solar-Cell Applications p 267-275 (SEE N86-26679 17-44)).

In fact, one of the main defects of this approach, according to what is indicated in US 2002/0021996, resides in that the cost of the raw materials does not allow to contain costs enough to make this process competitive with respect to the conventional process for the production of silicon starting from gaseous precursors.

There is, therefore, the need for a method for preparing silicon for photovoltaic use starting from metallurgical-grade silicon in which the use of raw materials with a reduced content of contaminants is combined with an optimization of the process, such as to keep the overall costs of the preparation method within acceptable limits.

### DISCLOSURE OF THE INVENTION

The aim of the present invention is to provide a method for preparing silicon for photovoltaic use with low-cost metallurgical techniques.

Within this aim, an object of the invention is to provide a method for preparing silicon for photovoltaic use, characterized by a lower impurity content than known processes that use metallurgical-grade silicon as raw material.

Another object of the invention is to provide a method for preparing silicon for photovoltaic use wherein no further impurities are introduced in the raw material being processed.

Still another object of the invention is to provide a method for preparing silicon for photovoltaic use that is highly reliable, relatively easy to provide and at competitive costs.

This aim, as well as these and other objects that will become better apparent hereinafter, are achieved by a method for preparing silicon for photovoltaic use starting from metallurgical-grade silicon, comprising the steps of:
(a) selecting (i) a silica powder having a content of boron (B) lower than 0.3 ppm by weight, phosphorus (P) lower than 0.1 ppm by weight and metallic impurities not exceeding 30 ppm by weight;
(ii) a carbon black having a B content of less than 0.1 ppm by weight, P less than 0.1 ppm by weight and metallic impurities not exceeding 30 ppm by weight; and
(iii) a binding agent selected from the group consisting of saccharose, starch, cellulose, polyvinyl alcohol, and NaSiO₃;
(b) preparing a mixture of said silica powder, said carbon black and said binding agent;
(c) preparing pellets of said mixture;
(d) subjecting said pellets to a first thermal treatment;
(e) subjecting said heat-treated pellets to carbon reduction, so as to obtain silicon in the molten state;
(f) subjecting said silicon in the molten state to a first purification;
(g) subjecting to directional solidification the silicon in the molten state in a directional solidification furnace, so as to obtain silicon for photovoltaic use,
   and wherein said steps (b) to (g) are performed in devices that have internal surfaces made of silico-aluminous ceramic materials that have a silica concentration of more than 99% by weight and are suitable to prevent silicon contamination.

### BRIEF DESCRIPTION OF THE DRAWINGS

Further characteristics and advantages of the invention will become better apparent from the detailed description that follows and from the accompanying drawings, wherein:

FIG. 1 is a chart of the steps of the method according to the invention in an embodiment thereof;

FIG. 2 is a schematic sectional view of a submerged arc furnace for carbon reduction used in an embodiment of the method according to the invention;

FIG. 3 is a schematic sectional view of a directional solidification furnace, used in an embodiment of the method according to the invention.

### WAYS OF CARRYING OUT THE INVENTION

The method of the present invention allows to prepare, starting from raw materials of high purity, a metallurgical-grade silicon of high quality, which can be used directly for photovoltaic use, avoiding the drawbacks suffered by the conventional method of purification of metallurgical-grade silicon, improving the yield of the finished product and reducing the use of potentially carcinogenic products.

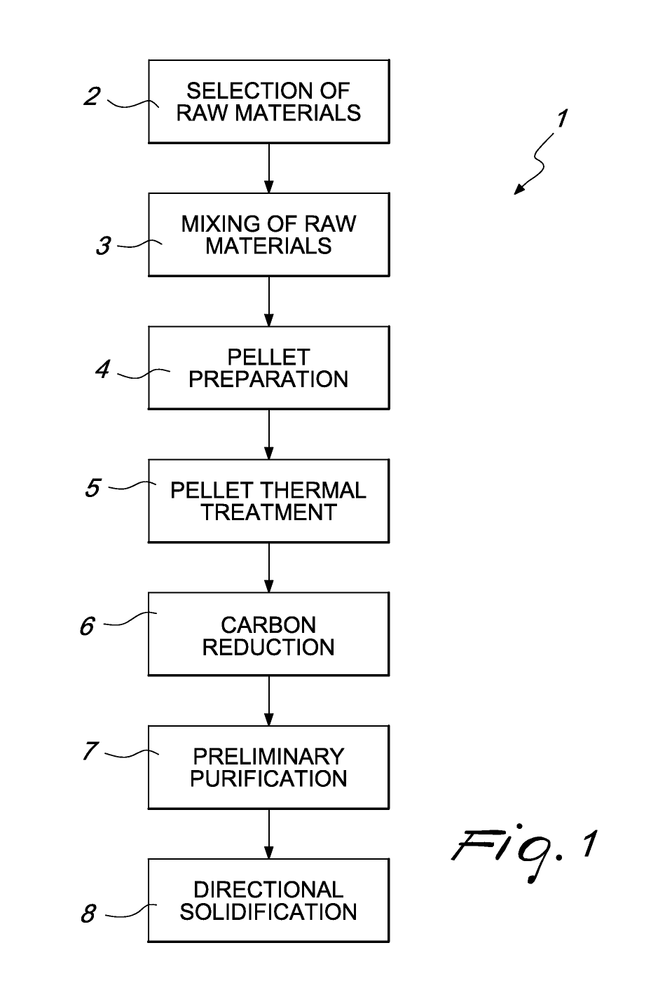

With reference to FIG. 1, the numeral 1 generally designates the method according to the present invention, which provides for the execution of a number of steps described here in greater detail. The first step, designated by the reference numeral 2, consists in selecting the raw materials required to prepare the silicon for photovoltaic use. These raw materials consist of (i) a quartz concentrate or a silica powder, for example a quartz sand, and (ii) a carbon black, which are then mixed with (iii) a binding agent.

The raw materials are selected and analyzed chemically beforehand in order to use, in the process according to the invention, materials that are characterized by a suitable degree of purity; in particular, the phosphorus content must be lower than 0.1 ppm by weight, the boron content must be possibly lower than 0.1 ppm by weight, and the content of metallic impurities must not exceed 30 ppm by weight.

The silica powder suitable for preparing silicon for photovoltaic use according to the method of the present invention may be characterized by a content of vanadium (V) from 1 to 5 ppm by weight, iron (Fe) from 0.1 to 5 ppm by weight, chromium (Cr) from 0.01 to 0.02 ppm by weight, titanium (Ti) from 0.8 to 3.5 ppm by weight, copper (Cu) from 0.05 to 0.5 ppm by weight; aluminum (Al) from 1.5 to 16 ppm by weight, calcium (Ca) from 1 to 5 ppm by weight, magnesium (Mg) from 0.1 to 1.5 ppm by weight, boron (B) less than 0.1 ppm by weight, and phosphorus (P) less than 0.1 ppm by weight.

Preferably, the silica powder may be characterized by a dimensional distribution of the particles that is comprised between 100 and 300 μm, so as to avoid the release into the environment of fine particles (PM10).

The carbon black suitable for use in the method according to the invention may be characterized by a content of V from 1 to 5 ppm by weight, Fe from 0.5 to 1.5 ppm by weight, Cr 1.6 ppm by weight, Ti 0.05 to 2 ppm by weight, nickel (Ni) less than 0.4 ppm by weight, B from 0.05 to 0.1 ppm by weight and P from 0.05 to 0.1 ppm by weight. Moreover, the carbon black is preferably without PAH (Polycyclic Aromatic Hydrocarbons), so as to not introduce in the raw materials substances that are potentially carcinogenic and so as to make the method compatible with national and international regulations.

The third component used in the preparation of silicon for photovoltaic use of the present method is a binding agent, used to form a mechanically strong interface of the carbonaceous type between the silica powder and the particles of carbon black. Preferably, the binding agent is selected from the group consisting of saccharose, starch, cellulose, polyvinyl alcohol and NaSiO₃. More preferably, the binding agent is saccharose.

The raw materials thus selected may be deposited in appropriately provided steel tanks, from which they are removed to perform the subsequent steps of the method according to the invention. Preferably, said tanks and the transfer systems used are lined with a fluorinated material, for example polyvinylidene fluoride (Kynar®), or with polyethylene, for example high-density polyethylene (HDPE). These linings prevent the silica powder, which has a high abrasive power, from abrading the steel of the tanks and thus remaining contaminated by the metallic particles thus generated. Preferably, the apparatuses used for weighing, mixing and compacting the raw materials also are lined with the above cited materials in order to avoid abrasive phenomena.

The silica powder, the carbon black and the binding agent are mixed during step 3 and the resulting mixture is used in step 4 for preparing the pellets. The three components are weighed separately and mixed mechanically, then the mixture is transferred into a compaction device with which the pellets are prepared. Preferably, the pellets have a size of 30 mm in width, 30 mm in length and 10 mm in thickness.

The components are mixed in such a composition as to comply with the stoichiometry of the process, although the dosage system is capable of varying within ±10% the total carbon quantity (carbon black and binding agent), keeping constant the quantity of quartz powder as a function of the operating conditions of the furnace, as is known to the person skilled in the art.

Preferably, the mixture receives the addition of water in a concentration that can vary between 2% and 7% by weight, preferably around 6%, so as to improve the distribution of the binding agent in the mixture.

The pellets obtained from the mixture of the three components are subsequently subjected to a thermal treatment step 5, in order to give them the desired degree of mechanical strength. This thermal treatment is performed by introducing the pellets in a tunnel furnace heated with indirect hot air to a temperature comprised between 150 and 250° C., preferably 250° C., for a period of duration of the thermal treatment comprised between 20 minutes and 1 hour, preferably 30 minutes.

At the end of the thermal treatment, the pellets are transferred into a submerged arc furnace, where the carbon reduction step 6 occurs and therefore the production of liquid silicon occurs.

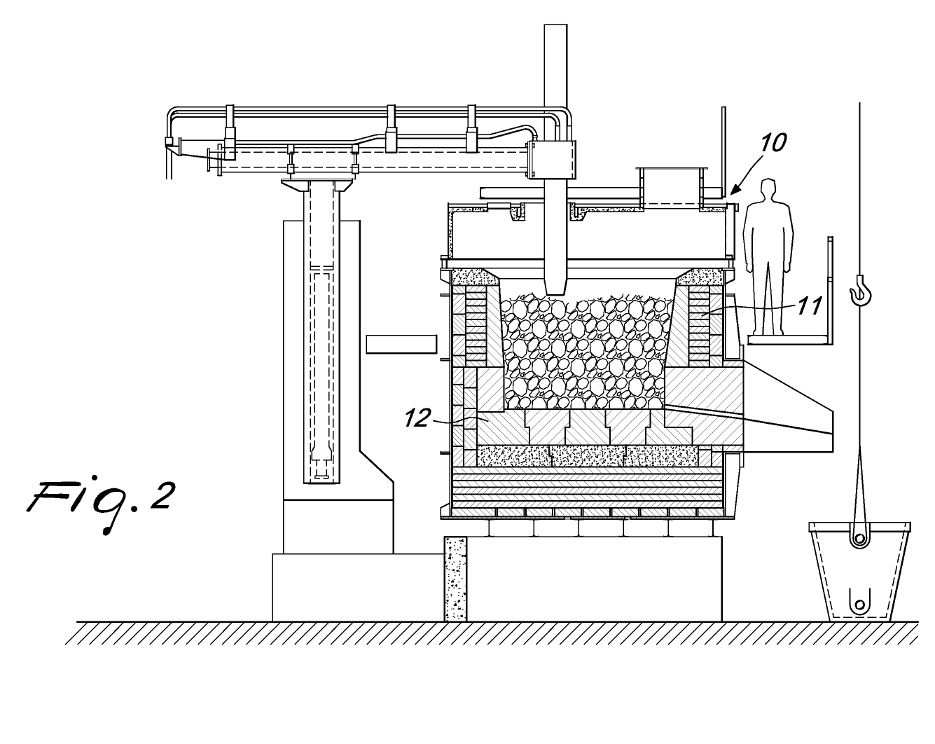

Said carbon reduction furnace, generally designated by the reference numeral 10 in FIG. 2, is a 2-MW furnace, which has three graphite electrodes and is provided in such a manner as to substantially reduce the possibility of contaminating the raw materials in the form of bricks and the silicon thus produced with any impurities. For this reason, the carbon reduction furnace is characterized by the presence of an internal surface of silico-aluminous bricks 11, which contain silica in a quantity from 65% to 95% by weight at the top, a crucible 12 having a high-purity graphite hearth which has a Fe content of less than 10 ppm by weight and an annular element made of the same high-purity graphite which has a Fe content of less than 10 ppm by weight. Moreover, the three electrodes also are made of high-purity graphite which has a Fe content of less than 10 ppm by weight, and are preferably characterized by a diameter comprised between 250 and 300 mm, preferably equal to 300 mm. Preferably, the graphite is characterized by the following composition: V from 5.1 to 5.8 ppm by weight, Fe less than 0.08 ppm by weight, Cr less than 0.02 ppm by weight, Ti 0.3 ppm by weight, Ni 0.2 ppm by weight, Al from 0.02 to 0.04 ppm by weight, B 0.05 ppm and P less than 0.02 ppm by weight.

Inside the carbon reduction furnace, the quartz contained in the pellets is converted into silicon in the molten state, operating the oven with a current at the electrodes comprised between 8 and 12 KA and a voltage comprised between 60 and 140 V. This conversion process, which in its essential outline is well-known to persons skilled in the art, allows higher efficiencies, higher than normal carbothermal processes, thanks to the particular configuration of the reagents.

In normal operating conditions, the daily production of molten silicon is comprised between 1900 and 2200 kg of material, with a conversion efficiency that is always higher than 80%. In these conditions, the interval between one casting and the next is comprised between 4 and 6 hours.

The silicon in the molten state is drawn periodically and transferred to a ladle, which has a lining made of a material that contains silica in a quantity from 80% to 95% by weight, with an iron content lower than 50 ppm by weight and with an inner surface constituted by quartz having a B content lower than 0.1 ppm by weight, inside which a first purification step, designated by the reference numeral 7 with reference to FIG. 1, is performed.

The lining of the ladle allows to avoid introducing metallic impurities in the silicon in the molten state, so as to keep the material at a suitable degree of purity.

The first purification step that is performed on the silicon in the molten state within the ladle consists of the partial removal of the carbon that is partly dissolved and partly present in the form of small crystals by means of a process, known to the person skilled in the art, of nucleation and growth of silicon carbide crystals (SiC). The formation of the crystals is induced with a suitable nucleation procedure, as is known to persons skilled in the art, by introducing a microcrystalline powder of silicon carbide in the silicon in the molten state for a time between 30 minutes and 2 hours, preferably two hours. With this treatment, at least part of these crystals falls onto the bottom of the ladle due to the different density of the silicon in the molten state (approximately 2.5 g/cm³) with respect to the density of the silicon carbide (approximately 3.2 g/cm³).

At the end of the procedure for preliminary purification by nucleation of the SiC crystals, the silicon in the molten state is advantageously transferred to a directional solidification furnace for final purification.

The transfer is performed through a filtration system, by way of which the SiC crystals that have formed in the preceding purification step are removed. In output from said filtration system, the silicon in the molten state is collected within a quartz crucible lined with silicon nitride and accommodated within a container made of a ceramic material based on alumina or silico-aluminates or, preferably, silicon carbide. This container allows to avoid the collapse of the quartz crucible at the high operating temperatures. The crucible is arranged inside a furnace for directional solidification, which is preheated to a temperature higher than 1450° C., so as to avoid unwanted solidification of the silicon on the walls of the crucible.

The silicon in the molten state is kept within the quartz crucible at a temperature comprised between 1420 and 1470° C., preferably 1450° C., for a time from 1 to 2 hours, preferably 2 hours, so as to complete carbon segregation.

Finally, the directional solidification step 8 is performed by progressive removal of heat from the bottom of the quartz crucible containing the silicon in the molten state at a rate of 2 to 10 cm/hour, preferably 6 cm/hour in inert atmosphere, preferably argon atmosphere. At the end of solidification, a silicon ingot usable for photovoltaic use is obtained.

In one embodiment, the directional solidification step can be conducted by selecting a suitable thermal cycle, so as to prevent the back scatter of the impurities from the top of the ingot, where they are more concentrated.

In one embodiment of the present invention, the method described here comprises the steps of:

(a) selecting (i) a silica powder having a content of vanadium (V) from 1 to 5 ppm by weight, iron (Fe) from 0.1 to 5 ppm by weight, chromium (Cr) from 0.01 to 0.02 ppm by weight, titanium (Ti) from 0.8 to 3.5 ppm by weight, copper (Cu) from 0.05 to 0.5 ppm by weight; aluminum (Al) from 1.5 to 16 ppm by weight, calcium (Ca) from 1 to 5 ppm by weight, magnesium (Mg) from 0.1 to 1.5 ppm by weight, boron (B) less than 0.1 ppm by weight, and phosphorus (P) less than 0.1 ppm by weight;
(ii) a carbon black without PAH having a content of V between 1 and 5 ppm by weight, Fe between 0.5 and 1.5 ppm by weight, Cr 1.6 ppm by weight, Ti from 0.05 to 2 ppm by weight, nickel (Ni) less than 0.4 ppm by weight, B from 0.05 to 0.1 ppm by weight, and P from 0.05 to 0.1 ppm by weight; and
(iii) a binding agent selected from the group consisting of saccharose, starch, cellulose, polyvinyl alcohol and NaSiO₃;
(b) preparing a mixture of said silica powder, said carbon black and said binding agent;
(c) preparing pellets of said mixture;
(d) subjecting said pellets to a first thermal treatment in a tunnel furnace heated with indirect hot air to a temperature comprised between 150 and 250° C. for a time comprised between 20 minutes and one hour;
(e) treating said pellets subjected to the first thermal treatment in a 2-MW submerged arc furnace which comprises three graphite electrodes that have a content of Fe of less than 10 ppm by weight; an inner surface of silico-aluminous bricks containing silica in a quantity from 65% to 95% by weight at the top; a crucible made with a high-purity graphite hearth with a Fe content of less than 10 ppm by weight and an annular element of high-purity graphite which has a Fe content of less than 10 ppm by weight, by operating said furnace with a current at the electrodes comprised between 8 and 12 KA and a voltage comprised between 60 and 140 V, so as to obtain silicon in the molten state;
(f) subjecting said silicon in the molten state to a procedure for nucleation and growth of silicon carbide (SiC) crystals in a ladle, said ladle having a lining made of a material containing silica in a quantity from 80 to 95% and less than 50 ppm of Fe and an inner surface constituted by quartz having a B content of less than 0.1 ppm by weight, so as to form SiC crystals;
(g) transferring through a filter said silicon in the molten state within which the SiC crystals have formed into a quartz crucible lined with silicon nitride, said crucible being accommodated in a container made of ceramic material based on alumina or silico-aluminates or, preferably, silicon carbide, said crucible being arranged within a furnace for directional solidification, which is preheated to a temperature above 1450° C., so as to remove the SiC crystals;
(g′) keeping said silicon in the molten state transferred into said quartz crucible within said furnace for directional solidification at a temperature from 1420 to 1470° C. for a time between 1 and 2 hours;
(g″) subjecting to directional solidification said silicon in the liquid state transferred into said quartz crucible within said furnace for directional solidification by progressive removal of heat from the bottom of said quartz crucible at a rate between 2 and 10 cm/hour in inert atmosphere, so as to obtain silicon for photovoltaic use.

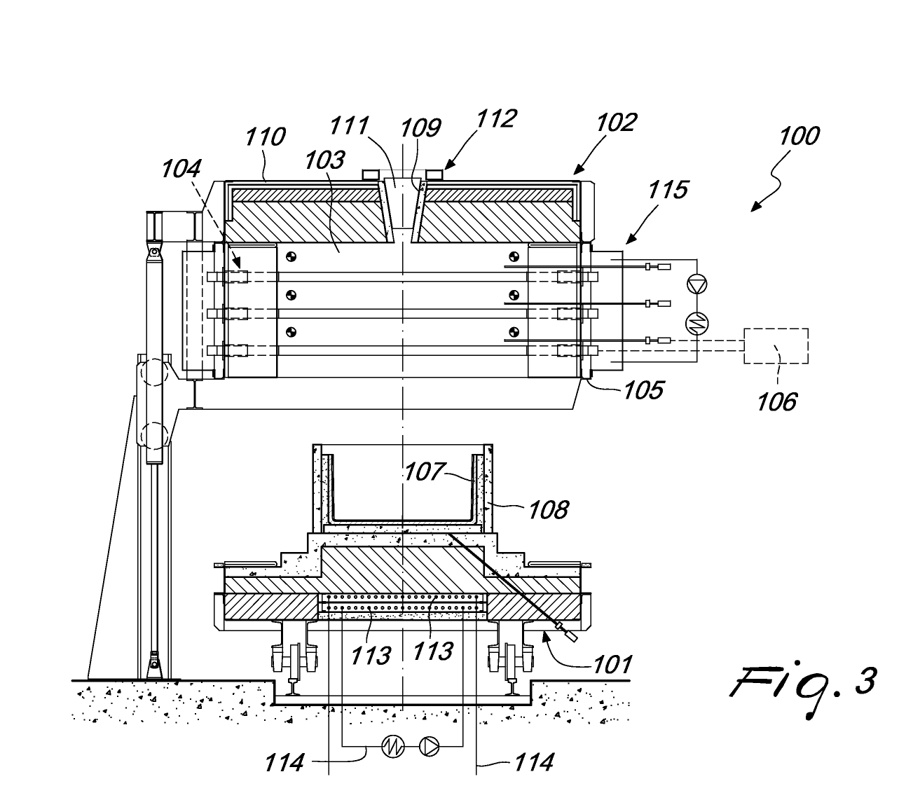

In a preferred embodiment of the method according to the invention, the furnace for directional solidification is an apparatus, generally designated by the reference numeral 100 in FIG. 3, characterized in that it comprises:
a furnace that comprises a footing 101 and a covering structure 102 which delimit a chamber 103, the former being able to move with respect to the latter or vice versa toward and away from each other along a vertical direction respectively for opening and closing said chamber;
heating means 104 of the electrical type, which are associated with the walls of said covering structure 105 and are associated with control means 106, suitable to activate them on command and to modulate the power delivered by them;
at least one quartz crucible 107, which is accommodated in a containment enclosure 108 that rests on said footing;
at least one opening 109, which is formed in the ceiling 110 of said covering structure and with which a closure element 111 of the removable type is associated;
means 112 for dispensing at least one inert gas, which are arranged proximate to said opening and are suitable to generate on command a barrier of said inert gas that covers at least the area of said opening, when said chamber is closed, said covering structure and said footing being moved mutually close, and said closure element is removed, for transfer through said opening of silicon in the molten state directly into said quartz crucible;
at least one heat exchange plate 113, which is cooled by a circuit 114 of a refrigerant fluid and is associated with said footing for the removal of heat from the bottom of said quartz crucible;
means 115 for feeding an inert gas inside said chamber when closed, said covering structure and said footing being moved mutually close, in order to generate inside said closed chamber an inert gas atmosphere at a pressure that is higher than atmospheric pressure.

In practice it has been found that the method according to the invention fully achieves the intended aim, since the use of raw materials characterized by a low content of boron and phosphorus allows to avoid the execution of specific purification steps for boron and phosphorus and to use a single directional solidification step.

Moreover, it has been observed that the use of a carbothermal furnace comprising graphite elements with a iron content of less than 10 ppm by weight and the use of a ladle with a lining having a high content of silica allows to avoid contamination of the silicon by metallic impurities.

It has also been observed that the method according to the invention allows to reduce the energy consumption of the production of silicon for photovoltaic use from metallurgical-grade silicon, since the molten silicon is transferred directly to the furnace for directional solidification without being solidified and then remelted.

Moreover, it has also been observed that the use of devices lined with abrasion-resistant material for preservation, transfer, mixing and compaction of the silica powder allows to avoid contamination of the material with metallic particles formed due to abrasion.

The method thus conceived is susceptible of numerous modifications and variations, all of which are within the scope of the appended claims; all the details may further be replaced with other technically equivalent elements.

In practice, the materials used, as well as the dimensions, may be any according to requirement and to the state of the art.

The disclosures in Italian Patent Application No. MI2008A001085 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-10. (canceled)

11. A method for preparing silicon for photovoltaic use starting from metallurgical-grade silicon, comprising the steps of:
(a) selecting (i) a silica powder having a content of boron (B) lower than 0.1 ppm by weight, phosphorus (P) lower than 0.1 ppm by weight and metallic impurities not exceeding 30 ppm by weight;
(ii) a carbon black having a B content of less than 0.1 ppm by weight, P less than 0.1 ppm by weight and metallic impurities not exceeding 30 ppm by weight; and
(iii) a binding agent selected from the group consisting of saccharose, starch, cellulose, polyvinyl alcohol, and NaSiO₃;
(b) preparing a mixture of said silica powder, said carbon black and said binding agent;
(c) preparing pellets of said mixture;
(d) subjecting said pellets to a first thermal treatment;
(e) subjecting said heat-treated pellets to carbon reduction, so as to obtain silicon in the molten state;
(f) subjecting said silicon in the molten state to a first purification;
(g) subjecting to directional solidification the silicon in the molten state with a directional solidification furnace, so as to obtain silicon for photovoltaic use, and wherein said steps (b) to (g) are performed in devices that have internal surfaces made of silico-aluminous ceramic materials that have a silica concentration of more than 99% by weight and are suitable to prevent silicon contamination.

12. The method according to claim 11, wherein the silica powder has a content of vanadium (V) from 1 to 5 ppm by weight, iron (Fe) from 0.1 to 5 ppm by weight, chromium (Cr) from 0.01 to 0.02 ppm by weight, titanium (Ti) from 0.8 to 3.5 ppm by weight, copper (Cu) from 0.05 to 0.5 ppm by weight; aluminum (Al) from 1.5 to 16 ppm by weight, calcium (Ca) from 1 to 5 ppm by weight, magnesium (Mg) from 0.1 to 1.5 ppm by weight, boron (B) less than 0.1 ppm by weight, and phosphorus (P) less than 0.1 ppm by weight.

13. The method according to claim 11, wherein the carbon black has no polycyclic aromatic hydrocarbons (PAH) and has a content of V from 1 to 5 ppm by weight, Fe from 0.5 to 1.5 ppm by weight, Cr 1.6 ppm by weight, Ti from 0.05 to 2 ppm by weight, nickel (Ni) less than 0.4 ppm by weight, B from 0.05 to 2 ppm by weight, and P from 0.05 to 0.1 ppm by weight.

14. The method according to claim 11, comprising the steps of
(a) selecting
(i) a silica powder having a content of vanadium (V) from 1 to 5 ppm by weight, iron (Fe) from 0.1 to 5 ppm by weight, chromium (Cr) from 0.01 to 0.02 ppm by weight, titanium (Ti) from 0.8 to 3.5 ppm by weight, copper (Cu) from 0.05 to 0.5 ppm by weight; aluminum (Al) from 1.5 to 16 ppm by weight, calcium (Ca) from 1 to 5 ppm by weight, magnesium (Mg) from 0.1 to 1.5 ppm by weight, boron (B) less than 0.1 ppm by weight, and phosphorus (P) less than 0.1 ppm by weight;
(ii) a carbon black without PAH having a content of V between 1 and 5 ppm by weight, Fe between 0.5 and 1.5 ppm by weight, Cr 1.6 ppm by weight, Ti from 0.05 to 2 ppm by weight, nickel (Ni) less than 0.4 ppm by weight, B from 0.05 to 0.1 ppm by weight, and P from 0.05 to 0.1 ppm by weight; and
(iii) a binding agent selected from the group constituted by saccharose, starch, cellulose, polyvinyl alcohol and NaSiO₃;
(b) preparing a mixture of said silica powder, said carbon black and said binding agent;
(c) preparing pellets of said mixture;
(d) subjecting said pellets to a first thermal treatment in a tunnel furnace heated with indirect hot air to a temperature comprised between 150 and 250° C. for a time comprised between 20 minutes and one hour;
(e) treating said pellets subjected to the first thermal treatment in a 2-MW submerged arc furnace (10) which comprises three graphite electrodes that have a content of Fe of less than 10 ppm by weight; an internal surface of silico-aluminous bricks (11) containing silica in a quantity from 65% to 95% by weight at the top; a crucible (12) made with a high-purity graphite hearth with a Fe content of less than 10 ppm by weight and an annular element of high-purity graphite which has a Fe content of less than 10 ppm by weight, operating said furnace with a current at the electrodes comprised between 8 and 12 KA and a voltage comprised between 60 and 140 V, so as to obtain silicon in the molten state;
(f) subjecting said silicon in the molten state to a procedure for nucleation and growth of silicon carbide (SiC) crystals in a ladle, said ladle having a lining made of a material containing silica in a quantity from 80 to 95% and less than 50 ppm of Fe and an inner surface constituted by quartz having a B content of less than 0.1 ppm by weight, so as to form SiC crystals;
(g) transferring through a filter said silicon in the molten state within which the SiC crystals have formed into a quartz crucible lined with silicon nitride, said crucible being accommodated in a container made of ceramic material based on alumina or silico-aluminates or silicon carbide, said crucible being arranged within a furnace for directional solidification, which is preheated to a temperature above 1450° C., so as to remove the SiC crystals;
(g′) keeping said silicon in the molten state transferred into said quartz crucible within said furnace for directional solidification at a temperature from 1420 to 1470° C. for a time between 1 and 2 hours;
(g″) subjecting to directional solidification said silicon in the liquid state transferred into said quartz crucible within said furnace for directional solidification by progressive removal of heat from the bottom of said quartz crucible at a rate between 2 and 10 cm/hour in inert atmosphere, so as to obtain silicon for hotovoltaic use.

15. The method according to claim 11, wherein the binding agent is saccharose.

16. The method according to claim 14, wherein the graphite is characterized by the following composition: V from 5.1 to 5.8 ppm by weight, Fe less than 0.08 ppm by weight, Cr less than 0.02 ppm by weight, Ti 0.3 ppm by weight, Ni 0.2 ppm by weight, Al from 0.02 to 0.04 ppm by weight, B 0.05 ppm and P less than 0.02 ppm by weight.

17. The method according to claim 14, wherein the furnace for directional solidification is an apparatus comprising:
a furnace that comprises a footing and a covering structure which delimit a chamber, the former being able to move with respect to the latter or vice versa toward and away from each other along a vertical direction respectively for opening and closing said chamber;
heating means of the electrical type, which are associated with the walls of said covering structure and are associated with control means, suitable to activate them on command and to modulate the power delivered by them;
at least one quartz crucible, which is accommodated in a containment enclosure that rests on said footing;
at least one opening, which is formed in the ceiling of said covering structure and with which a closure element of the removable type is associated;
means for dispensing at least one inert gas, which are arranged proximate to said opening and are suitable to generate on command a barrier of said inert gas that covers at least the area of said opening, when said chamber is closed, said covering structure and said footing being moved mutually close, and said closure element is removed, for transfer through said opening of silicon in the molten state directly into said quartz crucible;
at least one heat exchange plate, which is cooled by a circuit of a refrigerant fluid and is associated with said footing, for the removal of heat from the bottom of said quartz crucible;
means for feeding an inert gas inside said chamber when closed, said covering structure and said footing being moved mutually close, in order to generate inside said closed chamber an inert gas atmosphere at a pressure that is higher than atmospheric pressure.

18. The method according to claim 11, wherein the silica powder, the carbon black and the binding agent, before being mixed, are kept in steel tanks lined with a material selected from the group consisting of polyvinylidene fluoride and polyethylene.

19. The method according to claim 11, wherein the mixing of the silica powder, of the carbon black and of the binding agent occurs by means of a mixing device that is lined with a material selected from the group consisting of polyvinylidene fluoride and polyethylene.

20. The method according to claim 14, wherein preparation of the pellets occurs by means of a compaction device that is lined with a material selected from the group consisting of polyvinylidene fluoride and polyethylene.
